(19) United States
(12) Patent Application Publication
(10) Pub. No.: US 2020/0407266 A1
(43) Pub. Date: Dec. 31, 2020

(54) GLASS

(71) Applicant: Nippon Electric Glass Co., Ltd., Shiga (JP)

(72) Inventor: Ryota SUZUKI, Shiga (JP)

(21) Appl. No.: 16/971,139

(22) PCT Filed: Feb. 4, 2019
(86) PCT No.: PCT/JP2019/003768

§ 371 Date: Aug. 19, 2020

(30) Foreign Application Priority Data
Feb. 20, 2018 (JP) 2018-027511
Dec. 5, 2018 (JP) 2018-227771

(51) Int. Cl. C03C 3/093; C03C 3/091; C03C 3/089; C03C 3/087; C03C 3/097; C03B 17/06; C03B 23/03; C03C 17/06

(52) U.S. Cl. CPC C03C 3/093; C03C 3/091; C03C 3/089; C03C 3/087; C03C 2217/252; C03B 17/064; C03B 23/03; C03C 17/06; C03C 3/097

(57) ABSTRACT

The present invention provides a glass sheet, including as a glass composition, in terms of mass %, 50% to 75% of SiO₂, 0% to 25% of Al₂O₃, 0% to 25% of B₂O₃, 0% to 8% of Li₂O, 5% to 25% of Na₂O, 0% to 5% of K₂O, and 0% to 20% of MgO+CaO+SrO+BaO+ZnO, and having a softening point of 745° C. or less.

### TECHNICAL FIELD

The present invention relates to a glass having a low softening point suitable for curving work (thermal processing).

### BACKGROUND ART

In recent years, as head mounted displays, there have been developed, for example, a device configured to project an image onto a display hanging down from a brim of a hat, an eyeglass-type device configured to display a view of the outside of the device and an image on a display, and a device configured to display an image on a see-through light-guiding plate.

The device configured to display an image on the see-through light-guiding plate allows a user to see the image displayed on the light-guiding plate while seeing a view of the outside of the device through eyeglasses. The device can also implement 3D display through use of a technology of projecting different images onto left and right eyeglasses, and can also implement a virtual reality space through use of a technology of forming an image onto a retina by using a crystalline lens of an eye.

Those devices each require an optical member having a curved shape, and the optical member is produced by subjecting a glass sheet (glass having a sheet shape) to curving work.

### CITATION LIST

Patent Literature 1: US 2017/283305 A1

### SUMMARY OF INVENTION

### Technical Problem

In this connection, when the glass sheet is subjected to the curving work, it is required to subject the glass sheet to heat treatment at a temperature equal to or higher than a softening point. However, when the temperature of the heat treatment becomes higher, the lifetime of a mold or the like for performing the curving work is shortened. When the curving work is performed at low temperature in order to prolong the lifetime of the mold or the like, the glass sheet has a difficulty in being deformed while following the mold, resulting in a reduction in dimensional stability.

Soda lime glass is generally used as a window glass, but it is difficult to appropriately subject the soda lime glass to curving work because the soda lime glass has a softening point of about 750° C.

Meanwhile, when the curving workability of the glass sheet is to be improved by reducing the softening point of the glass sheet, the glass becomes unstable, and is liable to be devitrified at the time of forming.

The present invention has been made in view of the above-mentioned circumstances, and a technical object of the present invention is to devise a glass which can achieve both curving workability and devitrification resistance.

### Solution to Problem

The inventor of the present invention has repeatedly made various experiments, and as a result, has found that the above-mentioned technical object can be achieved by strictly restricting the contents of components of glass and restricting a softening point to a predetermined range. Thus, the finding is proposed as the present invention. That is, according to one embodiment of the present invention, there is provided a glass, comprising as a glass composition, in terms of mass %, 50% to 75% of SiO₂, 0% to 25% of Al₂O₃, 0% to 25% of B₂O₃, 0% to 8% of Li₂O, 5% to 25% of Na₂O, 0% to 5% of K₂O, and 0% to 20% of MgO+CaO+SrO+BaO+ZnO, and having a softening point of 745° C. or less. Herein, the content of “MgO+CaO+SrO+BaO+ZnO” refers to the total content of MgO, CaO, SrO, BaO, and ZnO. The “softening point” refers to a value measured in accordance with a method of ASTM C338.

In the glass according to the one embodiment of the present invention, the contents of the components are restricted as described above. With this, while the softening point is reduced, devitrification resistance can be improved.

In addition, in the glass according to the one embodiment of the present invention, the softening point is restricted to 745° C. or less. With this, thermal degradation of a mold or the like at the time of curving work is suppressed, and a glass sheet is easily changed in shape while following the shape of the mold.

In addition, it is preferred that the glass according to the one embodiment of the present invention comprise as a glass composition, in terms of mass %, 60% to 70% of SiO₂, 3% to less than 10% of Al₂O₃, 0% to 7% of B₂O₃, 0% to 1% of Li₂O, 13% to 23% of Na₂O, 0% to 0.1% of K₂O, 3% to 10% of MgO+CaO+SrO+BaO+ZnO, 0% to less than 3% of MgO, 2% to 10% of CaO, 0% to 2% of SrO, 0% to 2% of BaO, and 0% to 2% of ZnO, and have a softening point of 720° C. or less.

In addition, it is preferred that the glass according to the one embodiment of the present invention have a sheet shape.

In addition, it is preferred that the glass according to the one embodiment of the present invention be subjected to curving work.

In addition, it is preferred that at least one surface of the glass according to the one embodiment of the present invention have a surface roughness Ra of from 0.1 μm to 5 μm. The “surface roughness Ra” as used herein refers to an arithmetic average roughness Ra specified in JIS B0601-2001, but may be measured, for example, with a commercially available atomic force microscope (AFM) when the glass is formed by a down-draw method.

In addition, it is preferred that the glass according to the one embodiment of the present invention have a sheet thickness of from 0.1 mm to 3 mm.

In addition, it is preferred that the glass according to the one embodiment of the present invention comprise a functional film on at least one surface, and that the functional film be any one of an antireflection film, an antifouling film, a reflection film, and a scratch preventing film.

In addition, it is preferred that the glass according to the one embodiment of the present invention have a viscosity at a liquidus temperature of 10^{4.6} dPa·s or more. Herein, the “viscosity at a liquidus temperature” may be measured by a platinum sphere pull up method. The “liquidus temperature” may be calculated by measuring a temperature at which a crystal precipitates when glass powder which has passed through a standard 30-mesh sieve (500 μm) and remained on a 50-mesh sieve (300 μm) is placed in a platinum boat and then kept for 24 hours in a gradient heating furnace.

In addition, it is preferred that the glass according to the one embodiment of the present invention be formed by an overflow down-draw method.

In addition, it is preferred that the glass according to the one embodiment of the present invention be used as a member for a head mounted display.

### DESCRIPTION OF EMBODIMENTS

It is preferred that a glass of the present invention comprise as a glass composition, in terms of mass %, 50% to 75% of SiO₂, 0% to 25% of Al₂O₃, 0% to 25% of B₂O₃, 0% to 8% of Li₂O, 5% to 25% of Na₂O, 0% to 5% of K₂O, and 0% to 20% of MgO+CaO+SrO+BaO+ZnO. The reasons why the contents of the components are limited as described above are described below. In the descriptions of the contents of the components, the expression “%” represents mass % unless otherwise specified.

SiO₂ is a main component that forms a glass skeleton. When the content of SiO₂ is too small, a Young's modulus, acid resistance, and weather resistance are liable to be reduced. Therefore, a suitable lower limit of the content range of SiO₂ is 50% or more, 52% or more, 55% or more, 57% or more, or 60% or more, particularly 62% or more. Meanwhile, when the content of SiO₂ is too large, a softening point is inappropriately increased. Besides, a devitrified crystal is liable to be precipitated, and a liquidus temperature is liable to be increased. Therefore, a suitable upper limit of the content range of SiO₂ is 75% or less, 72% or less, 70% or less, 69% or less, or 68% or less, particularly 67% or less.

Al₂O₃ is a component that improves the Young's modulus and the weather resistance. A suitable lower limit of the content range of Al₂O₃ is 0% or more, 1% or more, 3% or more, 4% or more, or 5% or more, particularly 6% or more. Meanwhile, when the content of Al₂O₃ is too large, a viscosity at high temperature is increased, and curving workability is liable to be reduced. Therefore, a suitable upper limit of the content range of Al₂O₃ is 25% or less, 23% or less, less than 20%, less than 15%, 12% or less, 11% or less, or less than 10%, particularly 9% or less.

B₂O₃ is a component that forms the glass skeleton and acts as a melting accelerate component. When the content of B₂O₃ is too small, the liquidus temperature is liable to be reduced. Therefore, a suitable lower limit of the content range of B₂O₃ is 0% or more, 1% or more, 2% or more, or 3% or more, particularly 4% or more. Meanwhile, when the content of B₂O₃ is too large, the viscosity at high temperature is increased, and the curving workability is liable to be reduced. Therefore, a suitable upper limit of the content range of B₂O₃ is 25% or less, 20% or less, 15% or less, 13% or less, 11% or less, 10% or less, 9% or less, 8% or less, or 7% or less, particularly 6% or less.

Alkali metal oxides (Li₂O, Na₂O, and K₂O) are each a component that reduces the softening point. However, when the alkali metal oxides are introduced in large amounts, the viscosity of the glass is excessively reduced, and it becomes difficult to ensure a high liquidus viscosity. In addition, the Young's modulus is liable to be reduced. Therefore, a suitable lower limit of the total content range of Li₂O, Na₂O, and K₂O is 5% or more, 10% or more, 13% or more, 14% or more, 15% or more, 16% or more, or 17% or more, particularly 18% or more, and a suitable upper limit thereof is 27% or less, 25% or less, 23% or less, 22% or less, or 20% or less, particularly 19% or less. A suitable upper limit of the content range of Li₂O is 8% or less, 7% or less, 6% or less, 5% or less, 3% or less, 2% or less, 1% or less, or 0.5% or less, particularly 0.1% or less. A suitable lower limit of the content range of Na₂O is 5% or more, 6% or more, 7% or more, 8% or more, 9% or more, 10% or more, 11% or more, 12% or more, or 13% or more, particularly 14% or more, and a suitable upper limit thereof is 25% or less, 23% or less, 20% or less, or 18% or less, particularly 16% or less. A suitable lower limit of the content range of K₂O is 0% or more, particularly 0.1% or more, and a suitable upper limit thereof is 5% or less, 3% or less, 2% or less, 1% or less, or 0.5% or less, particularly 0.1% or less. A raw material for introducing K₂O contains larger amounts of harmful impurities (e.g., a radiation emitting element or a coloring element) than raw materials for introducing other components. Therefore, from the viewpoint of removing the harmful impurities, the content of K₂O is preferably 1% or less or 0.5% or less, particularly 0.1% or less.

A mass percent ratio (Na₂O—Al₂O₃)/SiO₂ is preferably −0.3 or more, −0.2 or more, −0.1 or more, −0.05 or more, more than 0, 0.05 or more, 0.1 or more, from 0.11 to 0.4, or from 0.12 to 0.3, particularly preferably from 0.15 to 0.25. When the mass percent ratio (Na₂O—Al₂O₃)/SiO₂ is too small, the softening point is liable to be increased. The “(Na₂O—Al₂O₃)/SiO₂” refers to a value obtained by dividing an amount obtained by subtracting the content of Al₂O₃ from the content of Na₂O by the content of SiO₂.

When a mass percent ratio Na₂O/(Li₂O+Na₂O+K₂O) is restricted to a predetermined range, while the softening point is reduced, devitrification resistance can be improved. A suitable lower limit of the range of the mass percent ratio Na₂O/(Li₂O+Na₂O+K₂O) is 0.4 or more, 0.5 or more, 0.6 or more, 0.7 or more, 0.8 or more, or 0.9 or more, particularly more than 0.95. The “Na₂O/(Li₂O+Na₂O+K₂O)” refers to a value obtained by dividing the content of Na₂O by the total content of Li₂O, Na₂O, and K₂O.

When a mass percent ratio Al₂O₃/(Li₂O+Na₂O+K₂O) is restricted to a predetermined range, while the weather resistance is maintained, the softening point can be reduced. A suitable lower limit of the range of the mass percent ratio Al₂O₃/(Li₂O+Na₂O+K₂O) is 0 or more, 0.1 or more, 0.2 or more, 0.25 or more, or 0.3 or more, particularly more than 0.35, and a suitable upper limit thereof is 1.6 or less, 1.5 or less, 1.2 or less, 1.1 or less, 1.0 or less, 0.8 or less, 0.7 or less, or 0.6 or less, particularly 0.5 or less. The “Al₂O₃/(Li₂O+Na₂O+K₂O)” refers to a value obtained by dividing the content of Al₂O₃ by the total content of Li₂O, Na₂O, and K₂O.

MgO, CaO, SrO, BaO, and ZnO are each a component that reduces the softening point. However, when MgO, CaO, SrO, BaO, and ZnO are introduced in large amounts, a density is excessively increased, and the Young's modulus is liable to be reduced. In addition, the viscosity at high temperature is excessively reduced, and it becomes difficult to ensure a high liquidus viscosity. Therefore, a suitable lower limit of the total content range of MgO, CaO, SrO, BaO, and ZnO is 0% or more, 0.1% or more, 0.5% or more, 1% or more, 2% or more, 2.5% or more, 3% or more, or 3.5% or more, particularly 4% or more, and a suitable upper limit thereof is 20% or less, 15% or less, 10% or less, or 8% or less, particularly 6% or less.

MgO is a component that reduces the softening point. In addition, among alkaline earth metal oxides, MgO is a component that effectively increases the Young's modulus. However, when the content of MgO is too large, the devitrification resistance and the weather resistance are liable to be reduced. A suitable lower limit of the content range of MgO is 0% or more or 0.1% or more, particularly 0.5% or more, and a suitable upper limit thereof is 8% or less, 5% or less, 3% or less, 2% or less, or 1% or less, particularly 0.9% or less.

CaO is a component that reduces the softening point. In addition, among the alkaline earth metal oxides, CaO is a component that reduces a raw material cost because a raw material for introducing CaO is relatively inexpensive. However, when the content of CaO is too large, the devitrification resistance and the weather resistance are liable to be reduced. A suitable lower limit of the content range of CaO is 0% or more, 0.1% or more, 1% or more, or 2% or more, particularly 3% or more, and a suitable upper limit thereof is 10% or less, 8% or less, 7% or less, or 6% or less, particularly 5% or less.

It is preferred that the content of CaO be larger than the content of K₂O. It is more preferred that the content of CaO be larger than the content of K₂O by 1 mass % or more. It is still more preferred that the content of CaO be larger than the content of K₂O by 2 mass % or more. When the content of CaO is smaller than the content of K₂O, it becomes difficult to achieve both a low softening point and high devitrification resistance.

When a mass percent ratio CaO/(MgO+CaO+SrO+BaO+ZnO) is restricted to a predetermined range, the raw material cost is reduced, and the softening point can also be reduced. A suitable lower limit of the range of the mass percent ratio CaO/(MgO+CaO+SrO+BaO+ZnO) is 0 or more, 0.1 or more, 0.2 or more, 0.3 or more, 0.4 or more, 0.5 or more, 0.6 or more, or 0.7 or more, particularly from more than 0.8 to 0.95. The “CaO/(MgO+CaO+SrO+BaO+ZnO)” refers to a value obtained by dividing the content of CaO by the total content of MgO, CaO, SrO, BaO, and ZnO.

SrO is a component that improves the devitrification resistance, but when the content of SrO is too large, the glass composition loses its component balance, and the devitrification resistance is liable to be reduced contrarily. In addition, harmful impurities are liable to be mixed in. Therefore, a suitable upper limit of the content range of SrO is 10% or less, 3% or less, 2% or less, or 1% or less, particularly 0.1% or less.

BaO is a component that improves the devitrification resistance, but when the content of BaO is too large, the glass composition loses its component balance, and the devitrification resistance is liable to be reduced contrarily. In addition, harmful impurities are liable to be mixed in. Therefore, a suitable upper limit of the content range of BaO is 10% or less, 3% or less, 2% or less, or 1% or less, particularly 0.1% or less.

ZnO is a component that remarkably reduces the softening point, but when the content of ZnO is too large, the glass is liable to be devitrified. Therefore, a suitable lower limit of the content range of ZnO is 0% or more, 0.1% or more, or 0.3% or more, particularly 0.5% or more, and a suitable upper limit thereof is 15% or less, 10% or less, 5% or less, 3% or less, or 2% or less, particularly less than 1%.

When a mass percent ratio ZnO/(MgO+CaO+SrO+BaO+ZnO) is restricted to a predetermined range, while the devitrification resistance is maintained, the softening point can be reduced. A suitable lower limit of the range of the mass percent ratio ZnO/(MgO+CaO+SrO+BaO+ZnO) is 0 or more, 0.05 or more, from 0.07 to 1.0, from 0.08 to 0.75, from 0.1 to 0.55, or from 0.15 to 0.5, particularly from more than 0.2 to 0.4. The “ZnO/(MgO+CaO+SrO+BaO+ZnO)” refers to a value obtained by dividing the content of ZnO by the total content of MgO, CaO, SrO, BaO, and ZnO.

Other components than the above-mentioned components may be introduced. From the viewpoint of properly exhibiting the effects of the present invention, the content of the other components than the above-mentioned components is preferably 12% or less, 10% or less, or 8% or less, particularly preferably 5% or less in terms of a total content.

P₂O₅ is a component that forms the glass skeleton. P₂O₅ is also a component that stabilizes the glass and improves the devitrification resistance. Meanwhile, when the content of P₂O₃ is too large, the glass is liable to undergo phase separation, and water resistance is liable to be reduced. A suitable upper limit of the content range of P₂O₃ is 5% or less, 3% or less, 2% or less, 1% or less, or 0.5% or less, particularly less than 0.1%.

TiO₂ and ZrO₂ are each a component that improves the acid resistance. However, when the contents of TiO₂ and ZrO₂ are too large, the devitrification resistance is liable to be reduced, and a transmittance is liable to be reduced. In addition, harmful impurities are liable to be mixed in. A suitable upper limit of the content range of TiO₂ is 5% or less, 3% or less, 2% or less, 1% or less, or 0.5% or less, particularly less than 0.1%. A suitable upper limit of the content range of ZrO₂ is 5% or less, 3% or less, 2% or less, 1% or less, or 0.5% or less, particularly less than 0.1%.

Fe₂O₃ is a component that is inevitably mixed in as an impurity, and the content of Fe₂O₃ is from 0.001% to 0.05%, or from 0.003% to 0.03%, particularly from 0.005% to 0.019%. When the content of Fe₂O₃ is too small, high-purity raw materials are required, and the raw material cost is liable to be increased. Meanwhile, when the content of Fe₂O₃ is too large, the transmittance is liable to be reduced.

As a fining agent, one kind or two or more kinds selected from the group consisting of As₂O₃, Sb₂O₃, CeO₂, SnO₂, F, Cl, and SO₃ may be added at from 0% to 2%. However, from an environmental viewpoint, it is preferred that the glass be substantially free of As₂O₃ and F, that is, the contents of As₂O₃ and F be less than 0.1%. In particular, in consideration of a fining ability and an environmental impact, SnO₂ is preferred as the fining agent. A suitable lower limit of the content range of SnO₂ is 0% or more or 0.1% or more, particularly 0.15% or more, and a suitable upper limit thereof is 1% or less, 0.5% or less, or 0.4% or less, particularly 0.3% or less. A suitable lower limit of the content range of Sb₂O₃ is 0% or more, 0.03% or more, or 0.05 or more, particularly 0.07% or more, and a suitable upper limit thereof is 1% or less, 0.5% or less, 0.4% or less, 0.3% or less, or 0.2% or less, particularly 0.1% or less.

PbO and Bi₂O₃ are each a component that reduces the viscosity at high temperature, but from an environmental viewpoint, it is preferred that the glass be substantially free of PbO and Bi₂O₃, that is, the contents of PbO and Bi₂O₃ be less than 0.1%.

Y₂O₃, La₂O₃, Nb₂O₅, Gd₂O₃, Ta₂O₅, and WO₃ each have an action of increasing the Young's modulus and the like. However, when each of the contents of those components is larger than 5%, particularly 1%, the raw material cost is increased.

The glass of the present invention preferably has the following characteristics.

A softening point is 745° C. or less, preferably 730° C. or less, particularly preferably from 600° C. to 720° C. When the softening point is too high, thermal degradation of a mold or the like at the time of curving work is promoted, and the glass has a difficulty in being changed in shape while following the shape of the mold.

An average linear thermal expansion coefficient within a temperature range of from 30° C. to 380° C. is preferably from 50×10⁻⁷/° C. to 125×10⁻⁷/° C., from 65×10⁻⁷/° C. to 110×10⁻⁷/° C., from 80×10⁻⁷/° C. to 105×10⁻⁷/° C., or from 85×10⁻⁷/° C. to 100×10⁻⁷/° C., particularly preferably from 88×10⁻⁷/° C. to 98×10⁻⁷/° C. When the average linear thermal expansion coefficient is outside the above-mentioned range, it becomes difficult to cause the thermal expansion coefficient to match the thermal expansion coefficients of various peripheral members (particularly, various metal films, and the like), and when a glass sheet is incorporated in a device, cracking or breakage of the glass sheet is liable to occur. The “average linear thermal expansion coefficient within a temperature range of from 30° C. to 380° C.” refers to a value measured with a dilatometer.

A liquidus temperature is preferably less than 850° C., 825° C. or less, 800° C. or less, 780° C. or less, or 760° C. or less, particularly preferably 750° C. or less. A viscosity at a liquidus temperature is preferably 10^{4.6} dPa·s or more, 10^{5.2} dPa·s or more, 10^{5.5} dPa·s or more, or 10^{5.8} dPa·s or more, particularly preferably 10^{6.0} dPa·s or more. With this, the glass sheet is easily formed by a down-draw method, particularly an overflow down-draw method, and hence a glass sheet having a small sheet thickness is easily produced. Further, a devitrified crystal is less liable to be generated in the glass at the time of forming. As a result, the manufacturing cost of the glass sheet can be reduced.

A temperature at a viscosity at high temperature of 10^{2.5} dPa·s is preferably 1,500° C. or less, 1,400° C. or less, 1,350° C. or less, or 1,320° C. or less, particularly preferably 1,300° C. or less. When the temperature at a viscosity at high temperature of 10^{2.5} dPa·s is increased, meltability is reduced, and the manufacturing cost of the glass is increased. The “temperature at a viscosity at high temperature of 10^{2.5} dPa·s” as used herein may be measured by a platinum sphere pull up method.

Incidentally, in glass manufacturing steps, in order to heat molten glass, an electrode is inserted into a melting bath, and the molten glass is directly heated through application of a current in some cases. A feeder, a forming device, or the like is indirectly heated through application of a current in some cases. However, in the case where the molten glass is heated through application of a current, when a difference in potential is caused between dissimilar metal members brought into contact with the molten glass, an electrical circuit is formed through the molten glass, and bubbles are generated at an interface between the metal and the molten glass corresponding to a positive electrode and a negative electrode in some cases.

Specifically, when the electrical circuit is formed, the following reaction occurs, and bubbles may be generated in a portion serving as a positive electrode side.

Positive electrode side: O²⁻→0.50₂+2e⁻

Negative electrode side: 0.5O₂+2e⁻→O²⁻

According to the Faraday's laws of electrolysis, the mass of a substance changed at an electrode during electrolysis is proportional to the quantity of electricity passed through the substance (see the following mathematical formula 1).

m=(Q·M)/(F·Z) [Math. 1]

m: mass (g) of the substance changed

Q: quantity (C) of electricity passed through the substance

M: molar mass (g/mol) of the substance

F: Faraday constant (C/mol)

Z: number of electrons involved in the change of the substance per molecule

Herein, the quantity Q of electricity is represented by the product of a current I and a time t (see the mathematical formula 2). In addition, according to the Ohm's law, a voltage is represented by the product of a resistance and a current (see the mathematical formula 3).

Q=I·t [Math. 2]

I: current (A)

t: time (sec)

E=R·I [Math. 3]

E: voltage (V)

R: resistance (Ω)

I: current (A)

The resistance R (Ω) is represented by the product of an electrical resistivity ρ (Ω·cm) of the glass and a cell constant K (cm⁻¹) determined by a measurement device (see the mathematical formula 4).

R=ρ·κ [Math. 4]

R: resistance (Ω)

ρ: electrical resistivity (Ω·cm)

κ: cell constant (cm⁻¹)

Based on the mathematical formulae 2 to 4, a relationship represented by the mathematical formula 5 is established between the quantity of electricity Q and the electrical resistivity ρ, and the quantity of electricity Q is inversely proportional to the electrical resistivity ρ. That is, it is found that, as the electrical resistivity ρ becomes higher, the quantity of electricity Q is reduced more, the mass m of the substance changed=the amount of bubbles is reduced more.

Q=(E·t)/(ρ·κ) [Math. 5]

In addition, the viscosity of the molten glass at the time of forming is substantially constant irrespective of the glass composition, and hence, as the electrical resistivity at the same viscosity becomes higher, the amount of bubbles generated at the time of forming is reduced more.

Therefore, it is preferred that the molten glass have a high electrical resistivity, and an electrical resistivity Log ρ at a measurement frequency of 1 kHz and a viscosity at high temperature of 10^{5.0} dPa·s is preferably 0.5 Ω·cm or more, 0.6 Ω·cm or more, 0.7 Ω·cm or more, 0.8 Ω·cm or more, 0.9 Ω·cm or more, or 1.0 Ω·cm or more, particularly preferably 1.1 Ω·cm or more. When the electrical resistivity Log ρ at a measurement frequency of 1 kHz and a viscosity at high temperature of 10^{5.0} dPa·s is too low, bubbles are generated in the molten glass, and bubble defects are increased, resulting in an increase in manufacturing cost of the glass. The “electrical resistivity Log ρ at a measurement frequency of 1 kHz and a viscosity at high temperature of 10^{5.0} dPa·s” as used herein may be measured by a two terminal method. The electrical resistivity Log ρ at a measurement frequency of 1 kHz and a viscosity at high temperature of 10^{5.0} dPa·s can be increased by increasing the content of B₂O₃ in the glass composition.

An electrical resistivity Log ρ at a measurement frequency of 1 kHz and a viscosity at high temperature of 10^{3.0} dPa·s is preferably 0.1 Ω·cm or more, 0.2 Ω·cm or more, 0.3 Ω·cm or more, 0.4 Ω·cm or more, 0.5 Ω·cm or more, or 0.6 Ω·cm or more, particularly preferably 0.7 Ω·cm or more. When the electrical resistivity Log ρ at a measurement frequency of 1 kHz and a viscosity at high temperature of 10^{3.0} dPa·s is too low, bubbles are generated in the molten glass, and bubble defects are increased, resulting in an increase in manufacturing cost of the glass. The “electrical resistivity Log ρ at a measurement frequency of 1 kHz and a viscosity at high temperature of 10^{3.0} dPa·s” as used herein may be measured by a two terminal method. The electrical resistivity Log ρ at a measurement frequency of 1 kHz and a viscosity at high temperature of 10^{3.0} dPa·s can be increased by increasing the content of B₂O₃ in the glass composition.

When a measurement temperature of the electrical resistivity is fixed (for example, when the electrical resistivity at a measurement frequency of 1 kHz and 1,300° C. is measured), the electrical resistivity is easily increased by increasing the content of SiO₂ in the glass composition, and the electrical resistivity is easily reduced by increasing the content of the alkali metal oxide.

The glass of the present invention is preferably formed by a down-draw method, particularly an overflow down-draw method. The overflow down-draw method is a method in which molten glass is caused to overflow from both sides of a heat-resistant trough-shaped structure, and the overflowing molten glasses are subjected to down-draw downward at the lower end of the trough-shaped structure while being joined, to thereby manufacture a glass sheet. By the overflow down-draw method, surfaces which are to serve as the surfaces of the glass sheet are formed in a state of free surfaces without being brought into contact with the trough-shaped refractory. As a result, a glass sheet having high surface smoothness is easily manufactured.

Other than the overflow down-draw method, for example, a slot down method, a redraw method, a float method, or a roll-out method may also be adopted as a method of forming the glass sheet.

The glass of the present invention has a low softening point as described above, and hence can be appropriately subjected to curving work so that the glass follows the shape of a mold or the like. Therefore, the glass of the present invention has a sheet shape preferably subjected to curving work, and more preferably subjected to curving work through heat treatment. In addition, when a curved shape is formed through the curving work, the radius of curvature of a curved surface thereof is set to preferably from 100 mm to 2,000 mm, particularly preferably from 200 mm to 1,000 mm. With this, the glass is easily applied to a member for a head mounted display.

In the glass of the present invention, at least one surface has a surface roughness Ra of preferably from 0.1 μm to 5 μm, particularly preferably from 0.3 μm to 3 μm. In particular, when the curving work is performed through heat treatment using a mold, the surface roughness Ra of a contact surface with the mold is restricted to preferably from 0.1 μm to 5 μm, particularly preferably from 0.3 μm to 3 μm. With this, the efficiency of the curving work can be increased without blurring a display image. When the surface roughness Ra of the contact surface with the mold is high, the surface roughness Ra can be reduced by fire polishing the surface.

The glass of the present invention having a sheet shape having been formed by a down-draw method may be used as it is without the curving work. In this case, the surface roughness Ra of a surface is preferably 10 nm or less, 9 nm or less, 8 nm or less, 7 nm or less, 6 nm or less, 5 nm or less, 4 nm or less, 3 nm or less, or 2 nm or less, particularly preferably 1 nm or less.

It is preferred that a compressive stress layer obtained through ion exchange be not formed on the surface of the glass of the present invention. With this, the manufacturing cost of the glass can be reduced.

The glass of the present invention preferably has a sheet shape, and the sheet thickness thereof is preferably 3.0 mm or less, 2.5 mm or less, 2.0 mm or less, 1.5 mm or less, or 1.0 mm or less, particularly preferably 0.9 mm or less. As the sheet thickness is reduced more, the weight of the glass sheet can be reduced more easily, and the curving work is performed more easily. Meanwhile, when the sheet thickness is too small, the strength of the glass sheet itself is reduced. Therefore, the sheet thickness is preferably 0.1 mm or more, 0.2 mm or more, 0.3 mm or more, 0.4 mm or more, 0.5 mm or more, or 0.6 mm or more, particularly preferably more than 0.7 mm.

It is preferred that the glass of the present invention have a sheet shape and comprise a functional film on at least one surface, and that the functional film be anyone of an antireflection film, an antifouling film, a reflection film, and a scratch preventing film.

As the antireflection film, for example, a dielectric multi-layer film in which a low-refractive-index layer having a relatively low refractive index and a high-refractive-index layer having a relatively high refractive index are alternately laminated on each other is preferred. With this, a reflectance at each wavelength is easily controlled. The antireflection film may be formed, for example, by a sputtering method or a CVD method. The reflectance of the antireflection film at each wavelength is, for example, preferably 1% or less, 0.5% or less, or 0.3% or less, particularly preferably 0.1% or less.

A composition for forming the antifouling film preferably contains a fluorine-containing silane compound, and the antifouling film is formed by coating the at least one surface with a solution of a silane compound having a fluoroalkyl group or a fluoroalkyl ether group. In particular, the fluorine-containing silane compound is preferably a silazane or an alkoxysilane. In addition, of the silane compounds each having a fluoroalkyl group or a fluoroalkyl ether group, a silane compound in which a fluoroalkyl group in the silane compound is bonded to a Si atom at such a ratio that one or less fluoroalkyl group is bonded to one Si atom, and the rest is a hydrolyzable group or a siloxane binding group is preferred. The “hydrolyzable group” as used herein is, for example, a group such as an alkoxy group. Such group is converted into a hydroxyl group through hydrolysis, and thus the silane compound forms a polycondensation product.

As the reflection film, a metal film formed of, for example, Al is preferred. As the scratch preventing film, an inorganic film formed of, for example, SiO₂ or Si₃N₄ is preferred.

### EXAMPLES

### Example 1

The present invention is hereinafter described based on Examples. The following Examples are merely illustrative. The present invention is by no means limited to the following Examples.

Examples (Sample Nos. 1 to 87) and Comparative Examples (Sample Nos. 88 and 89) of the present invention are shown in Tables 1 to 6.

TABLE 1

| Glass composition | | | | | | | | |
|---|---|---|---|---|---|---|---|---|
| (mass %) | No. 1 | No. 2 | No. 3 | No. 4 | No. 5 | No. 6 | No. 7 | No. 8 |
| SiO₂ | 67.7 | 67.7 | 67.7 | 67.7 | 65.7 | 65.7 | 65.9 | 65.9 |
| Al₂O₃ | 8.0 | 8.0 | 8.0 | 8.0 | 8.0 | 8.0 | 8.0 | 8.0 |
| B₂O₃ | 2.1 | 2.1 | 2.1 | 2.1 | 0.0 | 0.0 | 6.2 | 5.1 |
| P₂O₅ | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 15.2 | 14.8 | 14.4 | 14.0 | 20.3 | 20.3 | 15.5 | 16.6 |
| K₂O | 2.6 | 3.0 | 3.4 | 3.8 | 0.004 | 0.005 | 0.022 | 0.002 |
| MgO | 0.0 | 0.0 | 0.0 | 0.0 | 0.0 | 0.0 | 0.0 | 0.0 |
| CaO | 3.2 | 3.2 | 3.2 | 3.2 | 4.8 | 3.2 | 3.2 | 3.2 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| ZnO | 0.9 | 0.9 | 0.9 | 0.9 | 0.9 | 2.5 | 0.9 | 0.9 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 | 0.3 |
| Fe₂O₃ | 0.012 | 0.009 | 0.008 | 0.003 | 0.015 | 0.005 | 0.004 | 0.008 |
| Mg + Ca + Sr + Ba + Zn | 4.1 | 4.1 | 4.1 | 4.1 | 5.7 | 5.7 | 4.1 | 4.1 |
| (Na—Al)/Si | 0.11 | 0.10 | 0.09 | 0.09 | 0.19 | 0.19 | 0.11 | 0.13 |
| Na/(Li + Na + K) | 0.85 | 0.83 | 0.81 | 0.79 | 1.00 | 1.00 | 1.00 | 1.00 |
| Al/(Li + Na + K) | 0.45 | 0.45 | 0.45 | 0.45 | 0.39 | 0.39 | 0.52 | 0.48 |
| Ca/(Mg + Ca + Sr + Ba + Zn) | 0.78 | 0.78 | 0.78 | 0.78 | 0.84 | 0.56 | 0.78 | 0.78 |
| Zn/(Mg + Ca + Sr + Ba + Zn) | 0.22 | 0.22 | 0.22 | 0.22 | 0.16 | 0.44 | 0.22 | 0.22 |
| α (×10⁻⁷/° C.) | 95 | 95 | 95 | 95 | 107 | 106 | 85 | 89 |
| ρ (g/cm³) | 2.48 | 2.48 | 2.48 | 2.48 | 2.51 | 2.51 | 2.49 | 2.50 |
| Ps (° C.) | 492 | 490 | 491 | 491 | 481 | 473 | 516 | 509 |
| Ta (° C.) | 531 | 529 | 530 | 530 | 519 | 512 | 551 | 545 |
| Ts (° C.) | 710 | 709 | 711 | 711 | 694 | 691 | 713 | 707 |
| 10^{4.0} dPa · s (° C.) | 1,022 | 1,026 | 1,028 | 1,030 | 992 | 1,000 | 990 | 982 |
| 10^{3.0} dPa · s (° C.) | 1,214 | 1,222 | 1,222 | 1,226 | 1,170 | 1,182 | 1,164 | 1,157 |
| 10^{2.5} dPa · s (° C.) | 1,345 | 1,354 | 1,354 | 1,361 | 1,291 | 1,305 | 1,290 | 1,283 |
| Logρ (Ω · cm) 10^{5.0} | Not | Not | Not | Not | Not | Not | Not | Not |
| dPa · s | measured | measured | measured | measured | measured | measured | measured | measured |
| Logρ (Ω · cm) 10^{3.0} | Not | Not | Not | Not | Not | Not | Not | Not |
| dPa · s | measured | measured | measured | measured | measured | measured | measured | measured |
| TL (° C.) | Not | Not | Not | Not | 823 | 745 | 737 | Not |
| | measured | measured | measured | measured | | | | measured |
| Logη_{TL} | Not | Not | Not | Not | 5.6 | 6.7 | 7.1 | Not |
| | measured | measured | measured | measured | | | | measured |
| Young's modulus | 72 | 72 | 72 | 72 | 70 | 69 | 75 | Not |
| | | | | | | | | measured |

| Glass composition | | | | | | | |
|---|---|---|---|---|---|---|---|
| (mass %) | No. 9 | No. 10 | No. 11 | No. 12 | No. 13 | No. 14 | No. 15 |
| SiO₂ | 65.7 | 65.9 | 57.7 | 61.7 | 57.7 | 65.7 | 55.0 |
| Al₂O₃ | 8.0 | 8.0 | 4.0 | 4.0 | 8.0 | 4.0 | 6.4 |
| B₂O₃ | 2.1 | 4.7 | 13.6 | 9.6 | 9.6 | 5.6 | 14.3 |
| P₂O₅ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 19.8 | 16.7 | 20.3 | 20.3 | 20.3 | 20.3 | 20.0 |
| K₂O | 0.003 | 0.001 | 0.003 | 0.003 | 0.003 | 0.003 | 0.003 |
| MgO | 0.0 | 0.0 | 0.0 | 0.0 | 0.0 | 0.0 | 0.0 |
| CaO | 3.2 | 3.1 | 3.2 | 3.2 | 3.2 | 3.2 | 3.2 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.9 | 0.9 | 0.9 | 0.9 | 0.9 | 0.9 | 0.9 |
| ZrO₂ | 0.0 | 0.0 | 0.0 | 0.0 | 0.0 | 0.0 | 0.0 |
| SnO₂ | 0.3 | 0.4 | 0.3 | 0.3 | 0.3 | 0.3 | 0.3 |
| Fe₂O₃ | 0.004 | 0.001 | 0.002 | 0.003 | 0.003 | 0.003 | 0.003 |
| Mg + Ca + Sr + Ba + Zn | 4.1 | 4.0 | 4.1 | 4.1 | 4.1 | 4.1 | 4.1 |
| (Na—Al)/Si | 0.18 | 0.13 | 0.28 | 0.26 | 0.21 | 0.25 | 0.25 |
| Na/(Li + Na + K) | 1.00 | 1.00 | 1.00 | 1.00 | 1.00 | 1.00 | 1.00 |
| Al/(Li + Na + K) | 0.40 | 0.48 | 0.20 | 0.20 | 0.39 | 0.20 | 0.32 |
| Ca/(Mg + Ca + Sr + Ba + Zn) | 0.78 | 0.77 | 0.78 | 0.78 | 0.78 | 0.78 | 0.78 |
| Zn/(Mg + Ca + Sr + Ba + Zn) | 0.22 | 0.23 | 0.22 | 0.22 | 0.22 | 0.22 | 0.22 |
| α (×10⁻⁷/° C.) | 102 | 90 | 100 | 101 | 102 | 102 | 100 |
| ρ (g/cm³) | 2.50 | 2.50 | 2.54 | 2.54 | 2.53 | 2.52 | 2.54 |
| Ps (° C.) | 486 | 507 | 504 | 497 | 498 | 489 | 504 |
| Ta (° C.) | 522 | 542 | 535 | 529 | 529 | 523 | 534 |
| Ts (° C.) | 687 | 707 | 662 | 666 | 665 | 671 | 658 |
| 10^{4.0} dPa · s (° C.) | 969 | 983 | 844 | 869 | 871 | 906 | 834 |
| 10^{3.0} dPa · s (° C.) | 1,145 | 1,159 | 951 | 993 | 1,003 | 1,052 | 938 |
| 10^{2.5} dPa · s (° C.) | 1,268 | 1,283 | 1,030 | 1,085 | 1,101 | 1,157 | 1,016 |
| Logρ (Ω · cm) 10^{5.0} | Not | 1.34 | Not | Not | Not | Not | Not |
| dPa · s | measured | | measured | measured | measured | measured | measured |
| Logρ (Ω · cm) 10^{3.0} | Not | 0.65 | Not | Not | Not | Not | Not |
| dPa · s | measured | | measured | measured | measured | measured | measured |
| TL (° C.) | 804 | 809 | 708 | 714 | 768 | 748 | 749 |
| Logη_{TL} | 5.6 | 5.8 | 6.4 | 6.4 | 5.4 | 6.0 | 5.3 |
| Young's modulus | 71 | 75 | 78 | 76 | 76 | 73 | 78 |

TABLE 2

| Glass composition | | | | | | | | |
|---|---|---|---|---|---|---|---|---|
| (mass %) | No. 16 | No. 17 | No. 18 | No. 19 | No. 20 | No. 21 | No. 22 | No. 23 |
| SiO₂ | 59.1 | 53.9 | 63.3 | 57.9 | 52.8 | 67.5 | 56.8 | 65.8 |
| Al₂O₃ | 6.5 | 12.6 | 6.5 | 12.7 | 18.5 | 6.5 | 18.6 | 8.0 |
| B₂O₃ | 9.9 | 9.7 | 5.6 | 5.4 | 5.3 | 1.1 | 1.1 | 8.9 |
| P₂O₅ | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 20.1 | 19.6 | 20.3 | 19.7 | 19.2 | 20.4 | 19.3 | 12.8 |
| K₂O | 0.003 | 0.003 | 0.003 | 0.003 | 0.006 | 0.003 | 0.007 | 0.001 |
| MgO | 0.0 | 0.0 | 0.0 | 0.0 | 0.0 | 0.0 | 0.0 | 0.0 |
| CaO | 3.2 | 3.1 | 3.2 | 3.1 | 3.0 | 3.2 | 3.1 | 3.1 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| ZnO | 0.9 | 0.9 | 0.9 | 0.9 | 0.9 | 0.9 | 0.9 | 0.9 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 | 0.4 |
| Fe₂O₃ | 0.003 | 0.003 | 0.003 | 0.003 | 0.003 | 0.003 | 0.001 | 0.001 |
| Mg + Ca + Sr + Ba + Zn | 4.1 | 4.0 | 4.1 | 4.0 | 3.9 | 4.1 | 3.9 | 4.0 |
| (Na—Al)/Si | 0.23 | 0.13 | 0.22 | 0.12 | 0.01 | 0.20 | 0.01 | 0.07 |
| Na/(Li + Na + K) | 1.00 | 1.00 | 1.00 | 1.00 | 1.00 | 1.00 | 1.00 | 1.00 |
| Al/(Li + Na + K) | 0.32 | 0.64 | 0.32 | 0.64 | 0.96 | 0.32 | 0.96 | 0.63 |
| Ca/(Mg + Ca + Sr + Ba + Zn) | 0.78 | 0.78 | 0.78 | 0.78 | 0.78 | 0.78 | 0.78 | 0.77 |
| Zn/(Mg + Ca + Sr + Ba + Zn) | 0.22 | 0.22 | 0.22 | 0.22 | 0.22 | 0.22 | 0.22 | 0.23 |
| α (×10⁻⁷/° C.) | 101 | 100 | 103 | 101 | 100 | 105 | 101 | 75 |
| ρ (g/cm³) | 2.54 | 2.52 | 2.52 | 2.52 | 2.51 | 2.50 | 2.51 | 2.47 |
| Ps (° C.) | 498 | 496 | 490 | 498 | 506 | 473 | 516 | 532 |
| Ta (° C.) | 529 | 528 | 523 | 532 | 540 | 510 | 554 | 567 |
| Ts (° C.) | 662 | 662 | 669 | 682 | 699 | 679 | 743 | 731 |
| 10^{4.0} dPa · s (° C.) | 859 | 873 | 900 | 938 | 995 | 971 | 1,080 | 1,008 |
| 10^{3.0} dPa · s (° C.) | 980 | 1,012 | 1,049 | 1,101 | 1,174 | 1,147 | 1,273 | 1,183 |
| 10^{2.5} dPa · s (° C.) | 1,071 | 1,117 | 1,158 | 1,216 | 1,299 | 1,268 | 1,400 | 1,308 |
| Logρ (Ω · cm) 10^{5.0} | Not | Not | Not | Not | Not | Not | Not | 1.58 |
| dPa · s | measured | measured | measured | measured | measured | measured | measured | |
| Logρ (Ω · cm) 10^{3.0} | Not | Not | Not | Not | Not | Not | Not | 0.86 |
| dPa · s | measured | measured | measured | measured | measured | measured | measured | |
| TL (° C.) | 744 | 775 | 744 | 804 | 951 or | 736 | 978 or | 846 |
| | | | | | more | | more | |
| Logη_{TL} | 5.7 | 5.2 | 6.0 | 5.4 | 4.3 or | 6.6 | 4.8 or | 5.6 |
| | | | | | less | | less | |
| Young's modulus | 76 | 75 | 73 | 74 | 73 | 69 | 73 | 75 |

| Glass composition | | | | | | | |
|---|---|---|---|---|---|---|---|
| (mass %) | No. 24 | No. 25 | No. 26 | No. 27 | No. 28 | No. 29 | No. 30 |
| SiO₂ | 68.9 | 66.5 | 65.6 | 66.3 | 65.7 | 64.5 | 65.7 |
| Al₂O₃ | 5.8 | 8.3 | 8.0 | 8.1 | 8.7 | 8.0 | 7.2 |
| B₂O₃ | 10.2 | 9.7 | 9.2 | 8.8 | 8.9 | 9.0 | 8.9 |
| P₂O₅ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 10.7 | 11.1 | 13.2 | 13.2 | 13.3 | 13.0 | 12.9 |
| K₂O | 0.002 | 0.003 | 0.002 | 0.003 | 0.001 | 0.002 | 0.003 |
| MgO | 0.0 | 0.0 | 2.8 | 3.2 | 3.2 | 3.2 | 3.2 |
| CaO | 3.1 | 3.1 | 0.03 | 0.04 | 0.04 | 0.04 | 0.04 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.9 | 0.9 | 1.0 | 0.0 | 0.0 | 1.9 | 1.9 |
| ZrO₂ | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 |
| Fe₂O₃ | 0.002 | 0.003 | 0.005 | 0.005 | 0.005 | 0.005 | 0.005 |
| Mg + Ca + Sr + Ba + Zn | 4.0 | 4.0 | 3.8 | 3.3 | 3.3 | 5.1 | 5.1 |
| (Na—Al)/Si | 0.07 | 0.04 | 0.08 | 0.08 | 0.07 | 0.08 | 0.09 |
| Na/(Li + Na + K) | 1.00 | 1.00 | 1.00 | 1.00 | 1.00 | 1.00 | 1.00 |
| Al/(Li + Na + K) | 0.54 | 0.75 | 0.61 | 0.61 | 0.65 | 0.62 | 0.56 |
| Ca/(Mg + Ca + Sr + Ba + Zn) | 0.78 | 0.78 | 0.01 | 0.01 | 0.01 | 0.01 | 0.01 |
| Zn/(Mg + Ca + Sr + Ba + Zn) | 0.23 | 0.23 | 0.25 | 0.00 | 0.00 | 0.37 | 0.37 |
| α (×10⁻⁷/° C.) | 66 | 69 | 72 | 73 | 74 | 75 | 75 |
| ρ (g/cm³) | 2.44 | 2.44 | 2.43 | 2.42 | 2.42 | 2.45 | 2.45 |
| Ps (° C.) | 536 | 535 | 522 | 525 | 525 | 520 | 522 |
| Ta (° C.) | 573 | 571 | 559 | 562 | 562 | 557 | 558 |
| Ts (° C.) | 743 | 744 | 732 | 735 | 736 | 727 | 729 |
| 10^{4.0} dPa · s (° C.) | 1,034 | 1,039 | 1,035 | 1,044 | 1,050 | 1,031 | 1,027 |
| 10^{3.0} dPa · s (° C.) | 1,216 | 1,227 | 1,222 | 1,235 | 1,243 | 1,216 | 1,211 |
| 10^{2.5} dPa · s (° C.) | 1,347 | 1,364 | 1,351 | 1,367 | 1,376 | 1,342 | 1,336 |
| Logρ (Ω · cm) 10^{5.0} | 1.72 | 1.59 | Not | Not | Not | Not | Not |
| dPa · s | | | measured | measured | measured | measured | measured |
| Logρ (Ω · cm) 10^{3.0} | 1.03 | 0.94 | Not | Not | Not | Not | Not |
| dPa · s | | | measured | measured | measured | measured | measured |
| TL (° C.) | 921 | 877 | 924 | 975 | 949 | 975 | 957 |
| Logη_{TL} | 5.0 | 5.5 | 4.9 | 4.5 | 4.8 | 4.4 | 4.6 |
| Young's modulus | 77 | 75 | 73 | 73 | 72 | 72 | 73 |

TABLE 3

| Glass composition | | | | | | | | |
|---|---|---|---|---|---|---|---|---|
| (mass %) | No. 31 | No. 32 | No. 33 | No. 34 | No. 35 | No. 36 | No. 37 | No. 38 |
| SiO₂ | 65.2 | 63.2 | 61.9 | 64.4 | 60.5 | 64.2 | 66.0 | 64.8 |
| Al₂O₃ | 8.0 | 8.0 | 8.0 | 5.9 | 5.9 | 8.0 | 5.8 | 5.8 |
| B₂O₃ | 9.0 | 9.3 | 9.1 | 10.1 | 14.1 | 9.0 | 10.7 | 10.4 |
| P₂O₅ | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 13.3 | 13.1 | 12.5 | 13.2 | 13.0 | 12.2 | 13.1 | 12.4 |
| K₂O | 0.002 | 0.002 | 0.002 | 0.002 | 0.002 | 0.003 | 0.004 | 0.003 |
| MgO | 3.1 | 5.3 | 5.3 | 5.3 | 5.3 | 0.0 | 0.0 | 0.0 |
| CaO | 0.0 | 0.1 | 2.0 | 0.1 | 0.1 | 5.1 | 3.2 | 5.2 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| ZnO | 1.0 | 1.0 | 1.0 | 0.9 | 1.0 | 1.0 | 0.9 | 1.0 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 | 0.3 |
| Fe₂O₃ | 0.005 | 0.010 | 0.009 | 0.005 | 0.004 | 0.008 | 0.004 | 0.007 |
| Mg + Ca + Sr + Ba + Zn | 4.1 | 6.3 | 8.3 | 6.3 | 6.3 | 6.1 | 4.1 | 6.1 |
| (Na—Al)/Si | 0.08 | 0.08 | 0.07 | 0.11 | 0.12 | 0.07 | 0.11 | 0.10 |
| Na/(Li + Na + K) | 1.00 | 1.00 | 1.00 | 1.00 | 1.00 | 1.00 | 1.00 | 1.00 |
| Al/(Li + Na + K) | 0.60 | 0.61 | 0.64 | 0.44 | 0.45 | 0.66 | 0.44 | 0.47 |
| Ca/(Mg + Ca + Sr + Ba + Zn) | 0.00 | 0.01 | 0.25 | 0.01 | 0.01 | 0.84 | 0.77 | 0.84 |
| Zn/(Mg + Ca + Sr + Ba + Zn) | 0.24 | 0.15 | 0.11 | 0.15 | 0.15 | 0.16 | 0.23 | 0.16 |
| α (×10⁻⁷/° C.) | 75 | 76 | 76 | 76 | 76 | 75 | 75 | 77 |
| ρ (g/cm³) | 2.43 | 2.44 | 2.47 | 2.45 | 2.44 | 2.49 | 2.47 | 2.49 |
| Ps (° C.) | 523 | 521 | 522 | 520 | 516 | 531 | 530 | 531 |
| Ta (° C.) | 560 | 556 | 557 | 555 | 549 | 566 | 564 | 565 |
| Ts (° C.) | 731 | 722 | 718 | 716 | 696 | 724 | 721 | 718 |
| 10^{4.0} dPa · s (° C.) | 1,038 | 1,017 | 997 | 992 | 944 | 992 | 984 | 973 |
| 10^{3.0} dPa · s (° C.) | 1,228 | 1,195 | 1,165 | 1,161 | 1,094 | 1,160 | 1,148 | 1,127 |
| 10^{2.5} dPa · s (° C.) | 1,361 | 1,318 | 1,280 | 1,279 | 1,202 | 1,279 | 1,267 | 1,240 |
| Logρ (Ω · cm) 10^{5.0} | Not | Not | Not | Not | Not | Not | Not | Not |
| dPa · s | measured | measured | measured | measured | measured | measured | measured | measured |
| Logρ (Ω · cm) 10^{3.0} | Not | Not | Not | Not | Not | Not | Not | Not |
| dPa · s | measured | measured | measured | measured | measured | measured | measured | measured |
| TL (° C.) | Not | 884 | 1,009 | 887 | 868 | 930 | 867 | 878 |
| | measured | | | | | | | |
| Logη_{TL} | Not | 5.2 | 3.9 | 5.0 | 4.8 | 4.5 | 5.2 | 5.0 |
| | measured | | | | | | | |
| Young's modulus | 73 | 73 | 75 | 74 | 74 | 77 | 78 | 78 |

| Glass composition | | | | | | | |
|---|---|---|---|---|---|---|---|
| (mass %) | No. 39 | No. 40 | No. 41 | No. 42 | No. 43 | No. 44 | No. 45 |
| SiO₂ | 61.0 | 62.6 | 59.1 | 62.8 | 63.3 | 65.8 | 55.5 |
| Al₂O₃ | 5.8 | 8.1 | 0.1 | 1.0 | 2.0 | 3.0 | 4.8 |
| B₂O₃ | 14.3 | 0.0 | 12.0 | 15.0 | 16.0 | 17.0 | 18.7 |
| P₂O₅ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 12.3 | 25.0 | 23.0 | 17.0 | 15.0 | 11.0 | 16.6 |
| K₂O | 0.002 | 0.0 | 0.100 | 0.050 | 0.000 | 0.000 | 0.000 |
| MgO | 0.0 | 0.0 | 0.0 | 0.0 | 0.0 | 0.0 | 0.0 |
| CaO | 5.2 | 3.2 | 5.0 | 3.0 | 2.0 | 1.0 | 3.2 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 1.0 | 0.9 | 0.5 | 1.0 | 1.5 | 2.0 | 0.9 |
| ZrO₂ | 0.0 | 0.0 | 0.0 | 0.0 | 0.0 | 0.0 | 0.0 |
| SnO₂ | 0.3 | 0.3 | 0.2 | 0.2 | 0.2 | 0.2 | 0.3 |
| Fe₂O₃ | 0.008 | 0.005 | 0.003 | 0.003 | 0.003 | 0.003 | 0.003 |
| Mg + Ca + Sr + Ba + Zn | 6.1 | 4.1 | 5.5 | 4.0 | 3.5 | 3.0 | 4.1 |
| (Na—Al)/Si | 0.11 | 0.27 | 0.39 | 0.25 | 0.21 | 0.12 | 0.21 |
| Na/(Li + Na + K) | 1.00 | 1.00 | 1.00 | 1.00 | 1.00 | 1.00 | 1.00 |
| Al/(Li + Na + K) | 0.47 | 0.32 | 0.00 | 0.06 | 0.13 | 0.27 | 0.29 |
| Ca/(Mg + Ca + Sr + Ba + Zn) | 0.85 | 0.78 | 0.91 | 0.75 | 0.57 | 0.33 | 0.78 |
| Zn/(Mg + Ca + Sr + Ba + Zn) | 0.15 | 0.22 | 0.09 | 0.25 | 0.43 | 0.67 | 0.22 |
| α (×10⁻⁷/° C.) | 76 | 121 | 111 | 89 | 82 | 66 | 87 |
| ρ (g/cm³) | 2.49 | 2.52 | 2.56 | 2.53 | 2.51 | 2.42 | 2.51 |
| Ps (° C.) | 530 | 459 | 493 | 526 | 528 | 516 | 517 |
| Ta (° C.) | 562 | 495 | 523 | 556 | 560 | 552 | 547 |
| Ts (° C.) | 706 | 661 | 644 | 688 | 697 | 710 | 675 |
| 10^{4.0} dPa · s (° C.) | 931 | 948 | 810 | 874 | 895 | 962 | 854 |
| 10^{3.0} dPa · s (° C.) | 1,068 | 1,118 | 905 | 981 | 1,011 | 1,111 | 958 |
| 10^{2.5} dPa · s (° C.) | 1,169 | 1,234 | 975 | 1,060 | 1,096 | 1,220 | 1,034 |
| Logρ (Ω · cm) 10^{5.0} | Not | Not | Not | Not | Not | Not | 1.74 |
| dPa · s | measured | measured | measured | measured | measured | measured | |
| Logρ (Ω · cm) 10^{3.0} | Not | Not | Not | Not | Not | Not | 1.05 |
| dPa · s | measured | measured | measured | measured | measured | measured | |
| TL (° C.) | 841 | 841 | 670 or | 776 | 841 | 926 | 669 |
| | | | less | | | | |
| Logη_{TL} | 5.0 | 5.0 | 6.8 or | 5.5 | 4.7 | 4.3 | 7.8 or |
| | | | more | | | | less |
| Young's modulus | 78 | 67 | 77 | 81 | 80 | 74 | 79 |

TABLE 4

| Glass composition | | | | | | | | |
|---|---|---|---|---|---|---|---|---|
| (mass %) | No. 46 | No. 47 | No. 48 | No. 49 | No. 50 | No. 51 | No. 52 | No. 53 |
| SiO₂ | 59.7 | 54.4 | 63.9 | 58.5 | 53.4 | 62.6 | 59.1 | 51.4 |
| Al₂O₃ | 4.9 | 11.0 | 4.9 | 11.1 | 17.0 | 11.2 | 8.0 | 3.2 |
| B₂O₃ | 14.4 | 14.0 | 10.0 | 9.7 | 9.5 | 5.4 | 12.0 | 20.9 |
| P₂O₅ | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 16.7 | 16.3 | 16.8 | 16.4 | 16.0 | 16.5 | 16.6 | 20.1 |
| K₂O | 0.000 | 0.000 | 0.000 | 0.000 | 0.000 | 0.000 | 0.000 | 0.000 |
| MgO | 0.0 | 0.0 | 0.0 | 0.0 | 0.0 | 0.0 | 0.0 | 0.0 |
| CaO | 3.2 | 3.1 | 3.2 | 3.1 | 3.0 | 3.1 | 3.1 | 3.2 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| ZnO | 0.9 | 0.9 | 0.9 | 0.9 | 0.9 | 0.9 | 0.9 | 0.9 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 | 0.3 |
| Fe₂O₃ | 0.003 | 0.003 | 0.003 | 0.003 | 0.003 | 0.003 | 0.003 | 0.001 |
| Mg + Ca + Sr + Ba + Zn | 4.1 | 4.0 | 4.1 | 4.0 | 3.9 | 4.0 | 4.0 | 4.1 |
| (Na—Al)/Si | 0.20 | 0.10 | 0.19 | 0.09 | −0.02 | 0.08 | 0.14 | 0.33 |
| Na/(Li + Na + K) | 1.00 | 1.00 | 1.00 | 1.00 | 1.00 | 1.00 | 1.00 | 1.00 |
| Al/(Li + Na + K) | 0.29 | 0.68 | 0.29 | 0.68 | 1.06 | 0.68 | 0.48 | 0.16 |
| Ca/(Mg + Ca + Sr + Ba + Zn) | 0.78 | 0.78 | 0.78 | 0.78 | 0.78 | 0.78 | 0.78 | 0.78 |
| Zn/(Mg + Ca + Sr + Ba + Zn) | 0.22 | 0.22 | 0.22 | 0.22 | 0.22 | 0.22 | 0.22 | 0.22 |
| α (×10⁻⁷/° C.) | 88 | 87 | 89 | 88 | 88 | 90 | 88 | 101 |
| ρ (g/cm³) | 2.52 | 2.50 | 2.52 | 2.50 | 2.49 | 2.50 | 2.51 | 2.55 |
| Ps (° C.) | 520 | 512 | 518 | 514 | 514 | 513 | 514 | 501 |
| Ta (° C.) | 551 | 543 | 550 | 547 | 547 | 548 | 546 | 530 |
| Ts (° C.) | 685 | 681 | 692 | 693 | 702 | 708 | 686 | 644 |
| 10^{4.0} dPa · s (° C.) | 880 | 888 | 908 | 937 | 978 | 990 | 909 | 798 |
| 10^{3.0} dPa · s (° C.) | 996 | 1,019 | 1,041 | 1,092 | 1,155 | 1,170 | 1,045 | 881 |
| 10^{2.5} dPa · s (° C.) | 1,082 | 1,118 | 1,140 | 1,206 | 1,280 | 1,299 | 1,146 | 940 |
| Logρ (Ω · cm) 10^{5.0} | 1.64 | 1.59 | 1.56 | 1.49 | 1.38 | 1.31 | 1.58 | 1.65 |
| dPa · s | | | | | | | | |
| Logρ (Ω · cm) 10^{3.0} | 0.96 | 0.89 | 0.85 | 0.76 | 0.66 | 0.62 | 0.85 | 0.96 |
| dPa · s | | | | | | | | |
| TL (° C.) | 748 | 815 | 787 | 841 | 867 | 875 | 760 | 669 or |
| | | | | | | | | less |
| Logη_{TL} | 6.0 | 4.9 | 5.6 | 5.0 | 5.0 | 5.0 | 6.0 | 6.8 or |
| | | | | | | | | more |
| Young's modulus | 79 | 76 | 78 | 76 | 73 | 74 | 77 | 80 |

| Glass composition | | | | | | | |
|---|---|---|---|---|---|---|---|
| (mass %) | No. 54 | No. 55 | No. 56 | No. 57 | No. 58 | No. 59 | No. 60 |
| SiO₂ | 53.5 | 55.5 | 57.6 | 52.7 | 51.0 | 52.3 | 50.2 |
| Al₂O₃ | 3.2 | 3.2 | 3.3 | 6.3 | 6.3 | 6.3 | 6.2 |
| B₂O₃ | 18.8 | 16.6 | 14.4 | 14.8 | 14.8 | 15.0 | 15.0 |
| P₂O₅ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 20.2 | 20.2 | 20.3 | 20.0 | 20.0 | 19.9 | 19.7 |
| K₂O | 0.000 | 0.000 | 0.000 | 0.003 | 0.004 | 0.003 | 0.004 |
| MgO | 0.0 | 0.0 | 0.0 | 0.0 | 0.0 | 0.0 | 0.0 |
| CaO | 3.2 | 3.2 | 3.2 | 4.8 | 6.5 | 3.1 | 3.1 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.9 | 0.9 | 0.9 | 1.0 | 1.0 | 3.3 | 5.6 |
| ZrO₂ | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 |
| Fe₂O₃ | 0.001 | 0.002 | 0.003 | 0.005 | 0.010 | 0.009 | 0.005 |
| Mg + Ca + Sr + Ba + Zn | 4.1 | 4.1 | 4.1 | 5.8 | 7.5 | 6.4 | 8.7 |
| (Na—Al)/Si | 0.32 | 0.31 | 0.30 | 0.26 | 0.27 | 0.26 | 0.27 |
| Na/(Li + Na + K) | 1.00 | 1.00 | 1.00 | 1.00 | 1.00 | 1.00 | 1.00 |
| Al/(Li + Na + K) | 0.16 | 0.16 | 0.16 | 0.32 | 0.32 | 0.32 | 0.32 |
| Ca/(Mg + Ca + Sr + Ba + Zn) | 0.78 | 0.78 | 0.78 | 0.83 | 0.87 | 0.49 | 0.35 |
| Zn/(Mg + Ca + Sr + Ba + Zn) | 0.22 | 0.22 | 0.22 | 0.17 | 0.13 | 0.51 | 0.65 |
| α (×10⁻⁷/° C.) | 101 | 102 | 102 | 102 | 104 | 101 | 103 |
| ρ (g/cm³) | 2.55 | 2.55 | 2.55 | 2.55 | 2.57 | 2.57 | 2.60 |
| Ps (° C.) | 502 | 501 | 499 | 497 | 493 | 495 | 489 |
| Ta (° C.) | 531 | 531 | 529 | 526 | 522 | 525 | 519 |
| Ts (° C.) | 648 | 651 | 653 | 647 | 641 | 647 | 639 |
| 10^{4.0} dPa · s (° C.) | 807 | 812 | 823 | 814 | 800 | 815 | 803 |
| 10^{3.0} dPa · s (° C.) | 894 | 904 | 920 | 911 | 892 | 914 | 900 |
| 10^{2.5} dPa · s (° C.) | 957 | 970 | 992 | 982 | 960 | 987 | 970 |
| Logρ (Ω · cm) 10^{5.0} | 1.56 | 1.55 | 1.51 | Not | 1.62 | Not | 1.61 |
| dPa · s | | | | measured | | measured | |
| Logρ (Ω · cm) 10^{3.0} | 0.90 | 0.90 | 0.84 | Not | 0.98 | Not | 0.96 |
| dPa · s | | | | measured | | measured | |
| TL (° C.) | 720 | 703 | 691 or | 734 | 719 | 708 | 693 or |
| | | | less | | | | less |
| Logη_{TL} | 5.6 | 6.1 | 6.5 or | 5.34 | 5.4 | 5.9 | 5.9 or |
| | | | more | | | | more |
| Young's modulus | 79 | 79 | 78 | 78 | 78 | 77 | 76 |

TABLE 5

| Glass composition | | | | | | | | |
|---|---|---|---|---|---|---|---|---|
| (mass %) | No. 61 | No. 62 | No. 63 | No. 64 | No. 65 | No. 66 | No. 67 | No. 68 |
| SiO₂ | 55.1 | 55.9 | 54.7 | 55.2 | 56.1 | 57.4 | 55.1 | 58.1 |
| Al₂O₃ | 3.2 | 0.0 | 3.2 | 0.0 | 6.3 | 6.3 | 6.4 | 6.3 |
| B₂O₃ | 15.2 | 15.4 | 15.2 | 15.1 | 14.9 | 15.0 | 14.8 | 15.0 |
| P₂O₅ | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 20.4 | 20.6 | 20.2 | 20.2 | 20.1 | 20.1 | 20.1 | 20.1 |
| K₂O | 0.002 | 0.002 | 0.003 | 0.002 | 0.003 | 0.003 | 0.003 | 0.002 |
| MgO | 0.0 | 0.0 | 0.0 | 0.0 | 0.0 | 0.0 | 0.0 | 0.0 |
| CaO | 4.9 | 6.7 | 3.1 | 3.2 | 1.4 | 0.04 | 3.1 | 0.04 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| ZnO | 1.0 | 1.0 | 3.3 | 5.8 | 0.9 | 0.93 | 0.0 | 0.0 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 | 0.3 |
| Fe₂O₃ | 0.004 | 0.008 | 0.004 | 0.007 | 0.008 | 0.005 | 0.003 | 0.003 |
| Mg + Ca + Sr + Ba + Zn | 5.8 | 7.6 | 6.4 | 8.9 | 2.3 | 1.0 | 3.1 | 0.0 |
| (Na—Al)/Si | 0.31 | 0.37 | 0.31 | 0.37 | 0.25 | 0.24 | 0.25 | 0.24 |
| Na/(Li + Na + K) | 1.00 | 1.00 | 1.00 | 1.00 | 1.00 | 1.00 | 1.00 | 1.00 |
| Al/(Li + Na + K) | 0.16 | 0.00 | 0.16 | 0.00 | 0.31 | 0.32 | 0.32 | 0.32 |
| Ca/(Mg + Ca + Sr + Ba + Zn) | 0.83 | 0.87 | 0.49 | 0.35 | 0.60 | 0.04 | 1.00 | 1.00 |
| Zn/(Mg + Ca + Sr + Ba + Zn) | 0.17 | 0.13 | 0.51 | 0.65 | 0.40 | 0.96 | 0.00 | 0.00 |
| α (×10⁻⁷/° C.) | 101 | 106 | 101 | 104 | 98 | 96 | 100 | 96 |
| ρ (g/cm³) | 2.56 | 2.59 | 2.58 | 2.62 | 2.53 | 2.52 | 2.53 | 2.51 |
| Ps (° C.) | 500 | 501 | 498 | 496 | 504 | 508 | 501 | 509 |
| Ta (° C.) | 529 | 529 | 528 | 525 | 534 | 539 | 531 | 540 |
| Ts (° C.) | 650 | 648 | 649 | 645 | 661 | 668 | 656 | 670 |
| 10^{4.0} dPa · s (° C.) | 814 | 806 | 813 | 805 | 840 | 854 | 830 | 856 |
| 10^{3.0} dPa · s (° C.) | 907 | 894 | 909 | 894 | 947 | 962 | 933 | 968 |
| 10^{2.5} dPa · s (° C.) | 976 | 957 | 979 | 959 | 1,027 | 1,044 | 1,010 | 1,049 |
| Logρ (Ω · cm) 10^{5.0} | Not | 1.64 | Not | 1.62 | Not | 1.45 | 1.57 | 1.46 |
| dPa · s | measured | | measured | | measured | | | |
| Logρ (Ω · cm) 10^{3.0} | Not | 0.96 | Not | 0.94 | Not | 0.81 | 0.87 | 0.80 |
| dPa · s | measured | | measured | | measured | | | |
| TL (° C.) | 740 | 693 or | 681 or | 693 or | 742 | 693 or | 681 or | 693 or |
| | | less | less | less | | less | less | less |
| Logη_{TL} | 5.3 | 6.2 or | 6.6 or | 6.2 or | 5.6 | 6.9 or | 6.8 or | 6.9 or |
| | | more | more | more | | more | more | more |
| Young's modulus | 79 | 80 | 78 | 78 | 78 | 77 | 78 | 78 |

| Glass composition | | | | | | | |
|---|---|---|---|---|---|---|---|
| (mass %) | No. 69 | No. 70 | No. 71 | No. 72 | No. 73 | No. 74 | No. 75 |
| SiO₂ | 54.6 | 58.5 | 57.5 | 57.8 | 56.0 | 61.4 | 52.8 |
| Al₂O₃ | 6.4 | 6.4 | 12.6 | 11.0 | 6.7 | 7.4 | 10.8 |
| B₂O₃ | 14.8 | 10.6 | 5.5 | 6.7 | 11.6 | 11.4 | 7.5 |
| P₂O₅ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 19.9 | 20.1 | 19.9 | 19.9 | 19.2 | 10.5 | 17.4 |
| K₂O | 0.002 | 0.003 | 0.003 | 0.003 | 0.002 | 0.002 | 0.002 |
| MgO | 0.0 | 0.0 | 0.0 | 0.0 | 0.0 | 0.0 | 0.0 |
| CaO | 3.1 | 3.1 | 3.1 | 3.1 | 5.1 | 7.7 | 9.9 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.9 | 0.9 | 0.9 | 0.9 | 0.9 | 1.0 | 0.9 |
| ZrO₂ | 0.0 | 0.0 | 0.0 | 0.0 | 0.0 | 0.0 | 0.0 |
| SnO₂ | 0.3 | 0.3 | 0.3 | 0.3 | 0.3 | 0.3 | 0.3 |
| Fe₂O₃ | 0.001 | 0.001 | 0.002 | 0.003 | 0.005 | 0.003 | 0.003 |
| Mg + Ca + Sr + Ba + Zn | 4.0 | 4.0 | 4.0 | 4.0 | 6.0 | 8.7 | 10.8 |
| (Na—Al)/Si | 0.25 | 0.23 | 0.13 | 0.15 | 0.22 | 0.05 | 0.13 |
| Na/(Li + Na + K) | 1.00 | 1.00 | 1.00 | 1.00 | 1.00 | 1.00 | 1.00 |
| Al/(Li + Na + K) | 0.32 | 0.32 | 0.63 | 0.55 | 0.35 | 0.70 | 0.62 |
| Ca/(Mg + Ca + Sr + Ba + Zn) | 0.77 | 0.77 | 0.77 | 0.77 | 0.85 | 0.88 | 0.91 |
| Zn/(Mg + Ca + Sr + Ba + Zn) | 0.23 | 0.23 | 0.23 | 0.23 | 0.15 | 0.12 | 0.09 |
| α (×10⁻⁷/° C.) | 100 | 101 | 102 | 101 | 100 | 73 | 101 |
| ρ (g/cm³) | 2.54 | 2.54 | 2.52 | 2.52 | 2.55 | 2.50 | 2.58 |
| Ps (° C.) | 503 | 497 | 496 | 495 | 501 | 538 | 505 |
| Ta (° C.) | 533 | 528 | 529 | 527 | 531 | 572 | 536 |
| Ts (° C.) | 657 | 661 | 678 | 671 | 660 | 725 | 670 |
| 10^{4.0} dPa · s (° C.) | 830 | 860 | 930 | 907 | 847 | 972 | 874 |
| 10^{3.0} dPa · s (° C.) | 933 | 980 | 1,095 | 1,063 | 960 | 1,125 | 1,001 |
| 10^{2.5} dPa · s (° C.) | 1,011 | 1,070 | 1,214 | 1,179 | 1,044 | 1,239 | 1,095 |
| Logρ (Ω · cm) 10^{5.0} | 1.56 | 1.44 | 1.28 | 1.34 | 1.57 | 1.92 | 1.64 |
| dPa · s | | | | | | | |
| Logρ (Ω · cm) 10^{3.0} | 0.84 | 0.72 | 0.54 | 0.59 | 0.90 | 1.19 | 0.96 |
| dPa · s | | | | | | | |
| TL (° C.) | 704 | 720 | 793 | 767 | 766 | 972 or | Not |
| | | | | | | more | measured |
| Logη_{TL} | 6.3 | 6.2 | 5.5 | 5.7 | 5.17 | 4.0 or | Not |
| | | | | | | less | measured |
| Young's modulus | 78 | 76 | 74 | 74 | 77 | 78 | 78 |

TABLE 6

| Glass composition | | | | | | | | |
|---|---|---|---|---|---|---|---|---|
| (mass %) | No. 76 | No. 77 | No. 78 | No. 79 | No. 80 | No. 81 | No. 82 | No. 83 |
| SiO₂ | 56.1 | 59.5 | 60.4 | 60.6 | 60.1 | 58.9 | 57.5 | 57.3 |
| Al₂O₃ | 8.2 | 7.0 | 6.6 | 13.3 | 11.5 | 21.9 | 22.1 | 22.0 |
| B₂O₃ | 8.5 | 15.4 | 10.2 | 5.4 | 6.8 | 0.0 | 1.8 | 0.0 |
| P₂O₅ | 0.0 | 0.0 | 0.0 | 0.0 | 0.0 | 1.2 | 1.1 | 1.2 |
| Li₂O | 0.0 | 7.6 | 2.4 | 4.9 | 3.4 | 3.9 | 3.9 | 3.9 |
| Na₂O | 18.2 | 5.8 | 15.4 | 10.9 | 13.5 | 12.6 | 12.1 | 12.6 |
| K₂O | 0.002 | 0.0 | 0.002 | 0.002 | 0.002 | 0.004 | 0.004 | 0.004 |
| MgO | 0.0 | 0.0 | 0.0 | 0.0 | 0.0 | 0.02 | 0.01 | 1.3 |
| CaO | 8.3 | 3.4 | 3.2 | 3.2 | 3.2 | 0.012 | 0.006 | 0.015 |
| SrO | 0.0 | 0.0 | 0.0 | 0.0 | 0.0 | 0.002 | 0.0 | 0.0 |
| BaO | 0.0 | 0.0 | 0.0 | 0.0 | 0.0 | 0.008 | 0.0 | 0.0 |
| ZnO | 0.1 | 1.0 | 1.0 | 1.0 | 1.0 | 1.4 | 1.4 | 1.4 |
| ZrO₂ | 0.0 | 0.0 | 0.0 | 0.0 | 0.0 | 0.0 | 0.0 | 0.0 |
| SnO₂ | 0.3 | 0.3 | 0.3 | 0.3 | 0.3 | 0.1 | 0.1 | 0.1 |
| Fe₂O₃ | 0.001 | 0.001 | 0.002 | 0.010 | 0.009 | 0.005 | 0.005 | 0.006 |
| Mg + Ca + Sr + Ba + Zn | 8.4 | 4.4 | 4.2 | 4.2 | 4.2 | 1.5 | 1.4 | 2.7 |
| (Na—Al)/Si | 0.18 | −0.02 | 0.15 | −0.04 | 0.03 | −0.16 | −0.17 | −0.16 |
| Na/(Li + Na + K) | 1.00 | 0.43 | 0.86 | 0.69 | 0.80 | 0.76 | 0.76 | 0.76 |
| Al/(Li + Na + K) | 0.45 | 0.52 | 0.37 | 0.84 | 0.68 | 1.33 | 1.38 | 1.33 |
| Ca/(Mg + Ca + Sr + Ba + Zn) | 0.99 | 0.78 | 0.77 | 0.77 | 0.77 | 0.01 | 0.00 | 0.01 |
| Zn/(Mg + Ca + Sr + Ba + Zn) | 0.01 | 0.22 | 0.23 | 0.23 | 0.23 | 0.97 | 0.99 | 0.53 |
| α (×10⁻⁷/° C.) | 101 | 86 | 98 | 93 | 96 | 94 | 91 | 96 |
| ρ (g/cm³) | 2.56 | 2.48 | 2.52 | 2.49 | 2.50 | 2.46 | 2.46 | 2.48 |
| Ps (° C.) | 505 | 448 | 458 | 437 | 446 | 486 | 478 | 489 |
| Ta (° C.) | 536 | 476 | 489 | 469 | 478 | 528 | 518 | 530 |
| Ts (° C.) | 669 | 596 | 623 | 614 | 621 | 738 | 718 | 738 |
| 10^{4.0} dPa · s (° C.) | 869 | 773 | 829 | 870 | 862 | 1,118 | 1,100 | 1,100 |
| 10^{3.0} dPa · s (° C.) | 994 | 881 | 955 | 1,036 | 1,019 | 1,329 | 1,309 | 1,298 |
| 10^{2.5} dPa · s (° C.) | 1,087 | 963 | 1,050 | 1,153 | 1,133 | 1,461 | 1,441 | 1,423 |
| Logρ (Ω · cm) 10^{5.0} | 1.55 | 1.89 | 1.72 | 1.63 | 1.63 | Not | Not | Not |
| dPa · s | | | | | | measured | measured | measured |
| Logρ (Ω · cm) 10^{3.0} | 0.89 | 1.10 | 0.92 | 0.75 | 0.78 | Not | Not | Not |
| dPa · s | | | | | | measured | measured | measured |
| TL (° C.) | 896 | 751 | 760 | 844 | 849 | 926 or | 926 or | 902 |
| | | | | | | less | less | |
| Logη_{TL} | 3.7 | 4.3 | 4.9 | 4.2 | 4.1 | 5.4 or | 5.2 or | 5.5 |
| | | | | | | more | more | |
| Young's modulus | 77 | Not | 83 | 84 | 83 | Not | Not | Not |
| | | measured | | | | measured | measured | measured |

| Glass composition | | | | | | |
|---|---|---|---|---|---|---|
| (mass %) | No. 84 | No. 85 | No. 86 | No. 87 | No. 88 | No. 89 |
| SiO₂ | 54.9 | 64.6 | 65.6 | 65.2 | 55.5 | 59.0 |
| Al₂O₃ | 25.0 | 8.0 | 8.0 | 8.1 | 7.1 | 19.3 |
| B₂O₃ | 1.7 | 0.6 | 3.7 | 2.2 | 0.0 | 6.5 |
| P₂O₅ | 1.0 | 0.0 | 0.0 | 0.0 | 0.0 | 0.0 |
| Li₂O | 3.8 | 0.0 | 0.0 | 0.0 | 0.0 | 0.0 |
| Na₂O | 12.0 | 22.1 | 18.2 | 19.9 | 4.3 | 0.0 |
| K₂O | 0.003 | 0.000 | 0.001 | 0.003 | 7.0 | 0.0 |
| MgO | 0.01 | 0.0 | 0.0 | 0.0 | 1.9 | 2.5 |
| CaO | 0.010 | 3.1 | 3.1 | 3.1 | 2.1 | 6.3 |
| SrO | 0.0 | 0.0 | 0.0 | 0.0 | 8.9 | 0.5 |
| BaO | 0.0 | 0.0 | 0.0 | 0.0 | 8.5 | 5.7 |
| ZnO | 1.4 | 1.0 | 0.9 | 0.9 | 0.0 | 0.0 |
| ZrO₂ | 0.0 | 0.0 | 0.0 | 0.0 | 4.6 | 0.0 |
| SnO₂ | 0.1 | 0.4 | 0.4 | 0.4 | 0.2 | 0.2 |
| Fe₂O₃ | 0.005 | 0.002 | 0.001 | 0.003 | 0.020 | 0.022 |
| Mg + Ca + Sr + Ba + Zn | 1.4 | 4.1 | 4.0 | 4.0 | 21.4 | 15.0 |
| (Na—Al)/Si | −0.24 | 0.22 | 0.16 | 0.18 | −0.05 | −0.33 |
| Na/(Li + Na + K) | 0.76 | 1.00 | 1.00 | 1.00 | 0.38 | — |
| Al/(Li + Na + K) | 1.58 | 0.36 | 0.44 | 0.40 | 0.62 | — |
| Ca/(Mg + Ca + Sr + Ba + Zn) | 0.01 | 0.76 | 0.77 | 0.77 | 0.10 | 0.42 |
| Zn/(Mg + Ca + Sr + Ba + Zn) | 0.99 | 0.24 | 0.23 | 0.23 | 0.00 | 0.00 |
| α (×10⁻⁷/° C.) | 92 | 111 | 95 | 101 | 85 | 37 |
| ρ (g/cm³) | 2.46 | 2.51 | 2.50 | 2.50 | 2.82 | 2.52 |
| Ps (° C.) | 494 | 460 | 495 | 479 | 582 | 687 |
| Ta (° C.) | 535 | 497 | 530 | 515 | 628 | 743 |
| Ts (° C.) | 743 | 667 | 694 | 681 | 837 | 977 |
| 10^{4.0} dPa · s (° C.) | 1,125 | 965 | 970 | 968 | 1,150 | 1,285 |
| 10^{3.0} dPa · s (° C.) | 1,325 | 1,145 | 1,145 | 1,147 | 1,311 | 1,440 |
| 10^{2.5} dPa · s (° C.) | 1,449 | 1,266 | 1,269 | 1,270 | 1,411 | 1,540 |
| Logρ (Ω · cm) 10^{5.0} | Not | 1.15 | 1.37 | 1.25 | Not | Not |
| dPa · s | measured | | | | measured | measured |
| Logρ (Ω · cm) 10^{3.0} | Not | 0.37 | 0.64 | 0.57 | Not | Not |
| dPa · s | measured | | | | measured | measured |
| TL (° C.) | 904 | 833 | 806 | 808 | 1,010 | 1,123 |
| Logη_{TL} | 5.6 | 5.2 | 5.7 | 5.5 | 5.2 | 5.6 |
| Young's modulus | Not | 69 | 73 | 72 | 77 | 78 |
| | measured | | | | | |

First, a glass batch prepared by blending glass raw materials so that each glass composition listed in the tables was attained was placed in a platinum crucible, and then melted at from 1,200° C. to 1,500° C. for 4 hours. When the glass batch was dissolved, molten glass was stirred to be homogenized by using a platinum stirrer. Next, the resultant molten glass was poured out on a carbon sheet and formed into a sheet shape, and was then annealed at a rate of 3° C./min from a temperature higher than an annealing point Ta by about 20° C. to normal temperature. Each of the samples obtained was evaluated for an average linear thermal expansion coefficient α within a temperature range of from 30° C. to 380° C., a density p, a strain point Ps, an annealing point Ta, a softening point Ts, a temperature at a viscosity at high temperature of 10^{4.0} dPa·s, a temperature at a viscosity at high temperature of 10^{3.0} dPa·s, a temperature at a viscosity at high temperature of 10^{2.5} dPa·s, a liquidus temperature TL, a viscosity η at a liquidus temperature TL, and an electrical resistivity Log ρ.

The average linear thermal expansion coefficient α within a temperature range of from 30° C. to 380° C. is a value measured with a dilatometer.

The density ρ is a value measured by a well-known Archimedes method.

The strain point Ps, the annealing point Ta, and the softening point Ts are values measured in accordance with a method of ASTM C336 or ASTM C338.

The temperatures at viscosities at high temperature of 10^{4.0} dPa·s, 10^{3.0} dPa·s, and 10^{2.5} dPa·s are values measured by a platinum sphere pull up method.

The electrical resistivity Log ρ is a value measured at a measurement frequency of 1 kHz and a viscosity at high temperature of 10^{5.0} dPa·s or 10^{3.0} dPa·s by a two terminal method.

The liquidus temperature TL is a value obtained as follows: glass powder which has passed through a standard 30-mesh (500 μm) sieve and remained on a 50-mesh (300 μm) sieve is placed in a platinum boat and kept for 24 hours in a temperature gradient furnace, and then a temperature at which a crystal precipitates is measured through observation with a microscope. The viscosity η at a liquidus temperature TL is a value obtained by measuring the viscosity of the glass at the liquidus temperature TL by a platinum sphere pull up method.

As apparent from Tables 1 to 6, Sample Nos. 1 to 87 each had a softening point Ts of from 596° C. to 744° C. and a viscosity η at a liquidus temperature TL of 10³′⁷ dPa·s or more. Therefore, Sample Nos. 1 to 87 each had satisfactory curving workability and satisfactory devitrification resistance. Meanwhile, Sample Nos. 88 and 89 each had a softening point Ts of 837° C. or more, and hence it is considered to be difficult to subject Sample Nos. 88 and 89 to curving work.

### Example 2

The glasses (sheet thickness: 0.8 mm) according to Sample Nos. 1 to 87 were each subjected to curving work at a temperature around a softening point Ts so that the glass followed the shape of a mold. After that, a concave mirror was produced by forming a reflection film formed of Al on a surface of the glass on a concave side, on which display light was required to be reflected.

Meanwhile, the glasses (sheet thickness: 0.8 mm) according to Sample Nos. 88 and 89 were each subjected to curving work at a temperature around a softening point Ts so that the glass followed the shape of a mold, but thermal degradation was observed in the mold because the temperature of the curving work was high.

### INDUSTRIAL APPLICABILITY

The glass of the present invention is excellent in curving workability and devitrification resistance, and is hence suitable for a member for a head mounted display. Other than the above, the glass of the present invention, which is excellent in devitrification resistance, is also suitable for, for example, a cover glass for a CCD image sensor or a CMOS image sensor or a cover glass for a photodiode of light detection and ranging (LiDAR) for measuring a distance between cars. The glass of the present invention, which is excellent in curving workability (thermal processability), is also suitable for, for example, a pharmaceutical tube glass or an automotive center information display.

1. A glass, comprising as a glass composition, in terms of mass %, 50% to 75% of SiO₂, 0% to 25% of Al₂O₃, 0% to 25% of B203, 0% to 8% of Li₂O, 5% to 25% of Na₂O, 0% to 5% of K₂O, and 0% to 20% of MgO+CaO+SrO+BaO+ZnO, and having a softening point of 745° C. or less.

2. The glass according to claim 1, wherein the glass comprises as a glass composition, in terms of mass %, 60% to 70% of SiO₂, 3% to less than 10% of Al₂O₃, 0% to 7% of B203, 0% to 1% of Li₂O, 13% to 23% of Na₂O, 0% to 0.1% of K₂O, 3% to 10% of MgO+CaO+SrO+BaO+ZnO, 0% to less than 3% of MgO, 2% to 10% of CaO, 0% to 2% of SrO, 0% to 2% of BaO, and 0% to 2% of ZnO, and has a softening point of 720° C. or less.

3. The glass according to claim 1, wherein the glass has a sheet shape.

4. The glass according to claim 3, wherein the glass is subjected to curving work.

5. The glass according to claim 3, wherein at least one surface of the glass has a surface roughness Ra of from 0.1 μm to 5 μm.

6. The glass according to claim 3, wherein the glass has a sheet thickness of from 0.1 mm to 3 mm.

7. The glass according to claim 3,
wherein the glass comprises a functional film on at least one surface, and
wherein the functional film is any one of an antireflection film, an antifouling film, a reflection film, and a scratch preventing film.

8. The glass according to claim 1, wherein the glass has a viscosity at a liquidus temperature of 10^{4.6} dPa·s or more.

9. The glass according to claim 3, wherein the glass is formed by an overflow down-draw method.

10. The glass according to claim 1, wherein the glass is used as a member for a head mounted display.

11. The glass according to claim 2, wherein the glass has a sheet shape.

12. The glass according to claim 11, wherein the glass is subjected to curving work.

13. The glass according to claim 4, wherein at least one surface of the glass has a surface roughness Ra of from 0.1 μm to 5 μm.

14. The glass according to claim 4, wherein the glass has a sheet thickness of from 0.1 mm to 3 mm.

15. The glass according to claim 5, wherein the glass has a sheet thickness of from 0.1 mm to 3 mm.

16. The glass according to claim 4,
wherein the glass comprises a functional film on at least one surface, and
wherein the functional film is any one of an antireflection film, an antifouling film, a reflection film, and a scratch preventing film.

17. The glass according to claim 5,
wherein the glass comprises a functional film on at least one surface, and
wherein the functional film is any one of an antireflection film, an antifouling film, a reflection film, and a scratch preventing film.

18. The glass according to claim 6,
wherein the glass comprises a functional film on at least one surface, and
wherein the functional film is any one of an antireflection film, an antifouling film, a reflection film, and a scratch preventing film.

19. The glass according to claim 2, wherein the glass has a viscosity at a liquidus temperature of 10^{4.6} dPa·s or more.

20. The glass according to claim 3, wherein the glass has a viscosity at a liquidus temperature of 10^{4.6} dPa·s or more.
